(19) United States
(12) Patent Application Publication
(10) Pub. No.: US 2009/0033244 A1
(43) Pub. Date: Feb. 5, 2009

(54) INTEGRATED CIRCUIT WITH A PREHEAT CONTROL FOR A BALLAST

(75) Inventors: Gwo-Hwa Wang, Taipei City (TW); Jea-Sen Lin, Taipei County (TW); Ta-yung Yang, Milpitas, CA (US)

Correspondence Address: J C PATENTS, INC., 4 VENTURE, SUITE 250, IRVINE, CA, 92618, US

(73) Assignee: SYSTEM GENERAL CORP., Taipei Hsien (TW)

(21) Appl. No.: 11/833,805

(22) Filed: Aug. 3, 2007

(51) Int. Cl. H05B 41/36

(52) U.S. Cl. 315/291

(57) ABSTRACT

The present invention provides a ballast with preheat function for fluorescent or compact fluorescent lamps. The lamp is connected in series with an inductor and a capacitor to form a resonant circuit. A first switch and a second switch controlled by control circuit are coupled to the resonant circuit for switching the resonant circuit. A RC circuit is composed of a first resistor and a second resistor connected in series to form a voltage divider, and a capacitor is connected in parallel with second resistor. Switching frequency is voltage dependent.

### BACKGROUND OF THE INVENTION

1. Field of the Invention

The present invention generally relates to ballast, and more particularly, to ballast of fluorescent or compact fluorescent lamps with preheating filament function.

2. Description of Related Art

Fluorescent lamps are the most popular light sources in our life. Improvement of the efficiency of fluorescent lamps will significantly save energy. In recent development, how to improve the efficiency and save the power for a ballast of fluorescent lamp has become major research topic, but the results of the research in the recent years revealed that preheating filament before ignition of the lamp will help the filament to generate free electrons more easily and this can not only reduce ignition voltage between two ends of cathodes but also improve increasing the lifetime of the lamps. Most of conventional electronic ballasts are connected in parallel with one capacitor as a starting capacitor to the lamp to achieve preheat filament before lamp ignition, but glow current will occur during lamp preheating because of the voltage drop between the capacitor, and this will reduce the lifetime of lamps. FIG. 1 shows a conventional series resonant circuit of electronic ballast with preheating filament function using integrated circuit 60. The half-bridge inverter 4 is composed of two switches 41 and 42 controlled by signals S1 and S2 from integrated circuit 60. The two switches 41 and 42 are complimentarily switched on and off with about 50% duty cycle at the desired switching frequency controlled by a resistor 12 and a capacitor 14. The resonant circuit is composed of an inductor 80, a capacitor 81 and a fluorescent lamp 90. The fluorescent lamp 90 is connected in parallel with a capacitor 91. The capacitor 91 is operated as a starting capacitor. The preheat circuit 1 comprises a logic circuit 11, a resistor 12, a capacitor 14, and a switch 15 connected in series with a resistor 13. The preheat function is implemented by controlling the switch 15 to parallel the resistor 13 with the resistor 12 for higher frequency switching in response to the switching signal S3. The duration of the preheating of the filament is controlled by the logic circuit 11 before lamp ignition. A high starting frequency is employed to avoid stress on the lamp filament at startup and reduce the ignition voltage on lamps.

Another conventional electronic ballast with preheat function is shown in FIG. 2, which includes the integrated circuit 60, the half-bridge inverter 4 composed of two switches 41 and 42 controlled by signals S1 and S2 from the integrated circuit 60, the two switches 41 and 42, resistors 21 and 23, capacitors 22 and 24, the inductor 80, the capacitor 81, the fluorescent lamp 90 connected in parallel with a capacitor 91. The capacitor 91 is operated as a starting capacitor. The resistor 21 is employed for a preheating frequency, and the capacitor 22 is employed for setting a preheating time period. A resistor 23 and a capacitor 24 are employed for a run frequency.

### SUMMARY OF THE INVENTION

An objective of the present invention is to provide a ballast with preheat function by controlling a higher starting frequency in a desired preheat time.

A further objective of the present invention is to develop a low cost circuit for high efficiency performance.

The present invention provides a ballast with preheat function for fluorescent or compact fluorescent lamps. The lamp is connected to an inductor and a capacitor in series to develop a resonant circuit. A first switch and a second switch controlled by an integrated circuit are coupled to the resonant circuit for switching the resonant circuit. A RC circuit is composed of a first resistor, a second resistor and a capacitor, in which the first resistor is connected to the second resistor in series to form a voltage divider and the capacitor is connected to the second resistor in parallel. Switching frequency is voltage dependent.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the present invention.

FIG. 1 shows a first conventional electronic ballast.

FIG. 2 shows a second conventional electronic ballast.

FIG. 3 is a schematic diagram of ballast according to an embodiment of the present invention.

FIG. 4 shows a waveform of the ballast according to an embodiment of the present invention.

FIG. 5 shows a resonant tank Bode plot with lamp operating points according to an embodiment of the present invention.

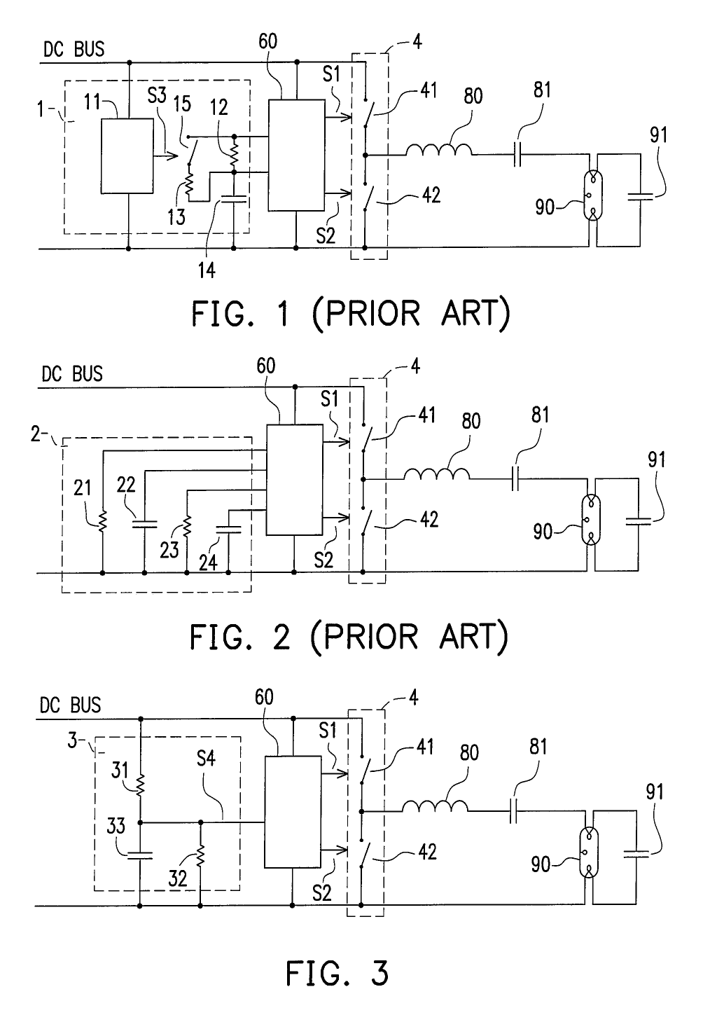

### DESCRIPTION OF THE INVENTION

FIG. 3 shows a schematic diagram of a ballast circuit according to an embodiment of the present invention. The ballast circuit comprises a lamp 90, a resonant circuit, a capacitor 91, a half-bridge 4, and an integrated circuit 60. The resonant circuit comprises an inductor 80 and a capacitor 81 connected in series. The capacitor 91 is connected to the lamp 90 in parallel and the capacitor 91 serves as a starting capacitor. The resonant circuit generates a sine wave voltage to operate the fluorescent lamp 90. The half-bridge 4 comprises switches 41 and 42 connected in series. The switch 41 is coupled to the resonant circuit and is controlled by a switching signal S1 from the integrated circuit 60. The switch 42 is coupled to the resonant circuit and is controlled by a switching signal S2 from the integrated circuit 60. The integrated circuit 60 provides switching signals S1 and S2 for the half-bridge inverter 4, sequence control, protections and compares the voltage signal S4 on an RC circuit 3 for frequency control. The RC circuit 3 includes a resistor 31, a resistor 32 and a capacitor 33. The resistor 31 and resistor 32 are connected in series and also serve as a voltage divider. The voltage level of the voltage signal S4 on capacitor 33 can be set by the ratio of the voltage divider, for example, formed by the resistor 31 and resistor 32, and influence the switching frequency.

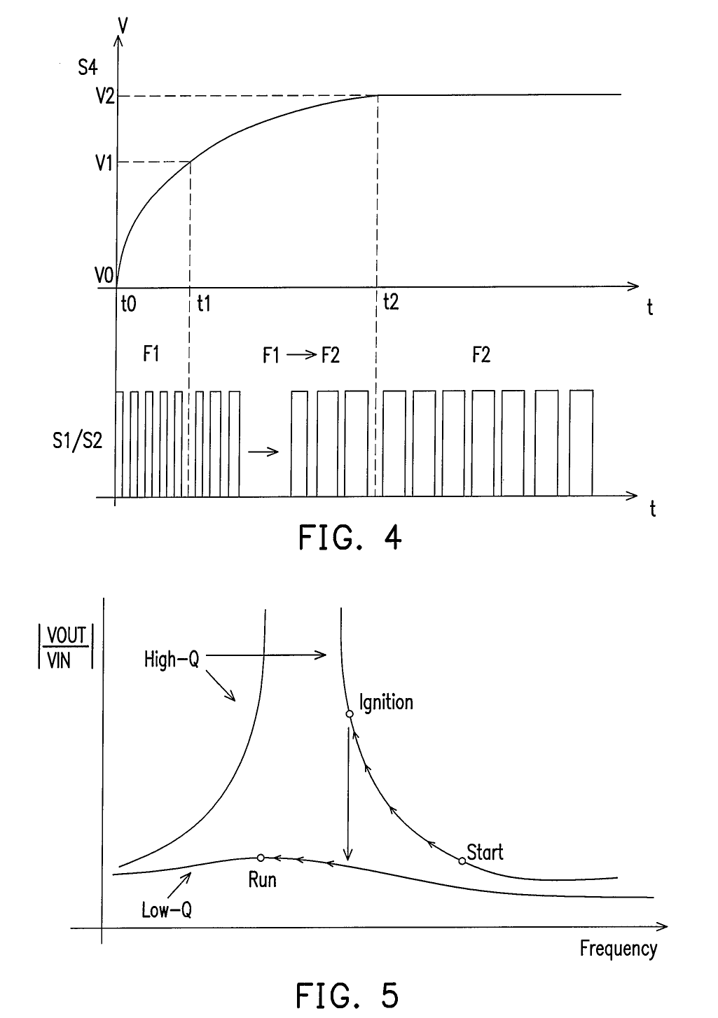

FIG. 4 shows a waveform of the voltage signal S4 from the RC circuit 3 compared with the switching signals S1 and S2 from the integrated circuit 60 for frequency control, as shown in FIG. 3. The RC circuit 3 is in the transient state during a period from t0 to t2, and the voltage signal S4 on the capacitor 33 will gradually increase during the period, and the voltage signal S4 on the RC circuit 3 is in a steady state after the time t2. The voltage level of the voltage signal S4 will rise up to a steady value according to the ratio of the voltage divider of the resistor 31 and the resistor 32. The voltage signal S4 on the capacitor 33 is given by,

$${V}_{C} = E ( 1 - {e}^{\frac{t}{RC}} ) \qquad ( 1 )$$

where Vc is the voltage on the capacitor 33, E is the voltage set by the ratio of voltage divider formed by the resistor 31 and the resistor 32, e is the natural logarithm that depends on the exponent of −t/RC, RC is the resistance of the resistor 31 and the capacitance of the capacitor 32, and t is a time constant.

The voltage level of the voltage signal S4 in the steady state in the RC circuit 3 is given by,

$${V}_{STEADY} = V ( \frac{{R}_{A}}{{R}_{A} + {R}_{B}} ) \qquad ( 2 )$$

where V is the voltage level of the DC bus, R_{A} is the resistor 31 in the RC circuit 3 and R_{B} is the resistor 32 in the RC circuit 3.

The impedance Xc of the capacitor 91 is given by,

$${X}_{C} = \frac{1}{2 π fC} \qquad ( 3 )$$

where f is the switching frequency, C is the capacitance of the capacitor 91. The impedance is an inverse proportion of frequency and capacitance of the capacitor 91.

In the beginning, the voltage signal S4 on the capacitor 33 is zero and will gradually rise up. When the voltage level of the voltage signal S4 is lower than a first threshold voltage V1 corresponding to the first time t1, the half-bridge inverter 4 switches at a first switching frequency F1 controlled by the integrated circuit 60. During the time period (t0˜t1), the half-bridge inverter 4 switches at a higher speed for preheating the filament to avoid stress on the lamp filament at startup and reduce ignition voltage on the lamp 90 (Preheat mode). The impedance of the capacitor 91 during the time period (t0˜t1) is small because of the frequency according to the equation 2, so that the current can pass through the filament to achieve preheating function. Once the filament is preheated, the ignition voltage and glow current is reduced and thereby extend the lifetime of the lamps.

When the voltage signal S4 is higher than the first threshold voltage V1, the switching frequency will ramp down to a second switching frequency F2 until the voltage level of the voltage signal S4 reaches a steady voltage V2. Between the first time and second time (t1˜t2), the switching frequency will be swept and passes through the high Q area of the resonant circuit to gain enough energy to ignite the lamp 90 (Ignition mode), and the impedance of the capacitor 91 will gradually rise up to control the voltage drop between the lamp 90. After the voltage signal S4 on the capacitor 33 reaches to the steady voltage V2, the steady state (Run mode) corresponding to second time t2 is reached. The half-bridge inverter 4 will stop sweeping the frequency and switches the frequency at the second switching frequency F2 controlled by the integrated circuit 60 and fixes in a reasonable tolerance. The switching frequency depends upon the voltage signal S4 on the capacitor 33 and preheat time depends upon the time constant of the RC circuit 3. FIG. 5 shows the resonant tank Bode plot with lamp operating points and is clearly disclosed above, including the start point, the ignition point, and the run point in response to the variation of the frequency.

While the present invention has been particularly shown and described with reference to preferred embodiments thereof, it will be understood by those of ordinary skill in the art that various changes in form and details may be made therein without departing from the spirit and scope of the present invention as defined by the appended claims.

1. A ballast circuit, comprising:
a resonant circuit, comprising a lamp, an inductor and a capacitor connected in series;
a half-bridge inverter, coupled to the resonant circuit and comprising a first switch and a second switch connected in series;
a RC circuit, comprising a capacitor, a first resistor and a second resistor, for providing a voltage signal for frequency control; and
an integrated circuit, coupled to the half-bridge inverter and the RC circuit for generating a first switching signal and a second switching signal to drive the half-bridge inverter in response to the voltage signal received by the RC circuit, and providing a sequence control, a frequency control and protections to the ballast circuit,
wherein the first switch and the second switch of the half-bridge inverter are complementarily switched on and off.

2. The ballast circuit as claimed in claim 1, wherein the first switch of the half bridge inverter is controlled by a first switching signal.

3. The ballast circuit as claimed in claim 1, wherein the second switch of the half-bridge inverter is controlled by a second switching signal.

4. (canceled)

5. The ballast circuit as claimed in claim 1, wherein the first resistor and second resistor are connected in series and a capacitor is connected to the second resistor in parallel.

6. The ballast circuit as claimed in claim 1, wherein the first resistor and the second resistor connected in series also serves as a voltage divider.

7. The ballast circuit as claimed in claim 6, wherein the voltage signal depends on a ratio of the voltage divider.

8. The ballast circuit as claimed in claim 1, wherein the RC circuit is employed for gradually increasing the voltage signal in a transient state and stabilizing it to a steady state.

9. The ballast circuit as claimed in claim 1, further comprising:
a first threshold voltage corresponding to a first time period for a first switching frequency; and
a steady voltage corresponding to a second time period for sweeping the first switching frequency to a second switching frequency between the first time period and the second time period.

10. The ballast circuit as claimed in claim 9, wherein the first threshold voltage is lower than the steady voltage.
